(19) United States
(12) Patent Application Publication
(10) Pub. No.: US 2021/0205164 A1
(43) Pub. Date: Jul. 8, 2021

(54) Family Tree Urn

(71) Applicant: Jennifer Anne Dredge, Bountiful, UT (US)

(72) Inventor: Jennifer Anne Dredge, Bountiful, UT (US)

(21) Appl. No.: 17/140,900

(22) Filed: Jan. 4, 2021

Related U.S. Application Data
(60) Provisional application No. 62/956,394, filed on Jan. 2, 2020.

(51) Int. Cl. A61G 17/08; B44F 7/00

(52) U.S. Cl. CPC A61G 17/08; B44F 7/00

(57) ABSTRACT

A family tree urn is an apparatus that includes a stand and at least one container that is mounted thereto by fastening means. Preferably, the stand interlocks with a slot within a round base. Where after the base projects a plurality of protrusions that accommodates the mounting of the at least one container thereto. By mounting the at least one container to a more stable stand and assembly thereof, the at least one container mitigates the disturbance and possible destruction of the container. Further, by providing the plurality of protrusions to which the at least one container may mount to, the apparatus additionally addresses the concentration of multiple containers, particularly in deference to the sensitive nature an urn should be countenanced for. Thus, the apparatus introduces a comprehensive assembly that localizes at least one container to a stationary stand that mitigates damages thereto and may accommodate greater than one container.

The current application claims a priority to the U.S. Provisional Patent application Ser. No. 62/956,394 filed on Jan. 2, 2020. The current application is filed on Jan. 4, 2021 while Jan. 2, 2021 was on a weekend.

### FIELD OF THE INVENTION

The present invention relates generally to a container, particularly a container that can accommodate a plurality of containers about a stand through a singularity of fastening means.

### BACKGROUND OF THE INVENTION

Presently, containers for the deceased are known to the art. They are conventionally singular in count and purpose and isolated from additional urns that may come into a person's life. This accumulation of isolated containers about a particular location portends damage and mis location of the particular containers, particularly in an urn's capacity to house, carry, and preserve the ashes of the deceased. Thus, an apparatus that can contain multiple containers and hold them securely without any disturbance is a rare find in the current market.

It is an objective of the present invention to provide users with an assembly that comprises a stand and at least one container that is mounted thereto by fastening means. According to a preferred embodiment of the present invention, the stand interlocks with a slot within a round base. Where after the base projects a plurality of protrusions that accommodates the mounting of the at least one container thereto. By mounting the at least one container to a more stable stand and assembly thereof, the at least one container better mitigates the disturbance and possible destruction of the container. Further, by providing the plurality of protrusions to which the at least one container may mount to, the apparatus additionally addresses the concentration of multiple containers, particularly in deference to the sensitive nature an urn should be countenanced for. Thus, the invention introduces a comprehensive assembly that localizes at least one container to a stationary stand that mitigates damages thereto and may accommodate greater than one container.

### BRIEF DESCRIPTION OF THE DRAWINGS

FIG. 1 is a top-front-left perspective view of the present invention

FIG. 2 is a front elevational view of the present invention.

FIG. 3 is a front elevational view of the present invention, wherein only the stand is shown.

FIG. 4 is a rear elevational view of the present invention.

FIG. 5 is a top plane view of the present invention.

FIG. 6 is a side elevational of the present invention.

FIG. 7 is an exploded top-front-rear perspective view of a leaf shaped container of the present invention.

FIG. 8 is a rear elevational view of the leaf shaped container of the present invention.

FIG. 9 is a sectional view of the container, taken along A-A′ of FIG. 8.

### DETAIL DESCRIPTIONS OF THE INVENTION

All illustrations of the drawings are for the purpose of describing selected versions of the present invention and are not intended to limit the scope of the present invention.

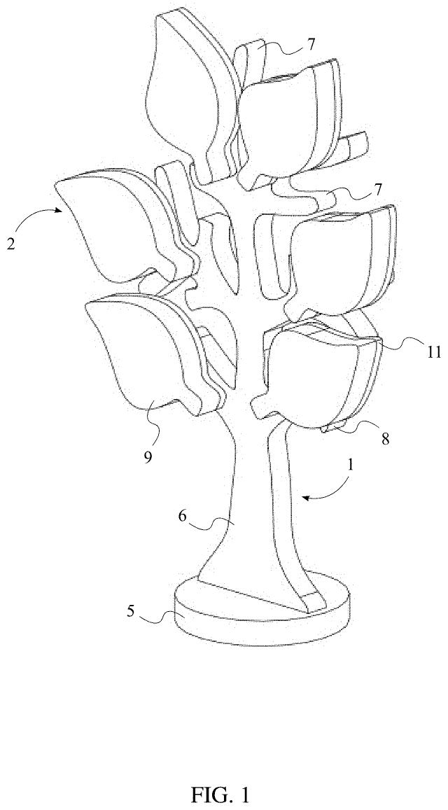

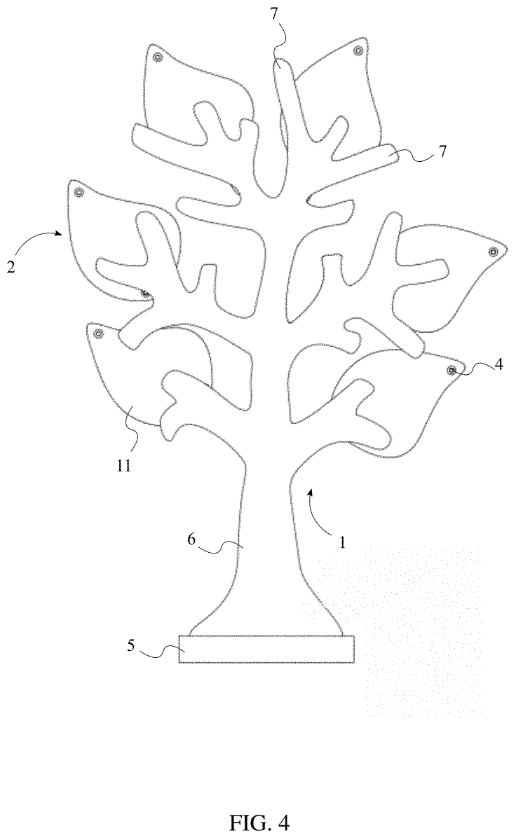

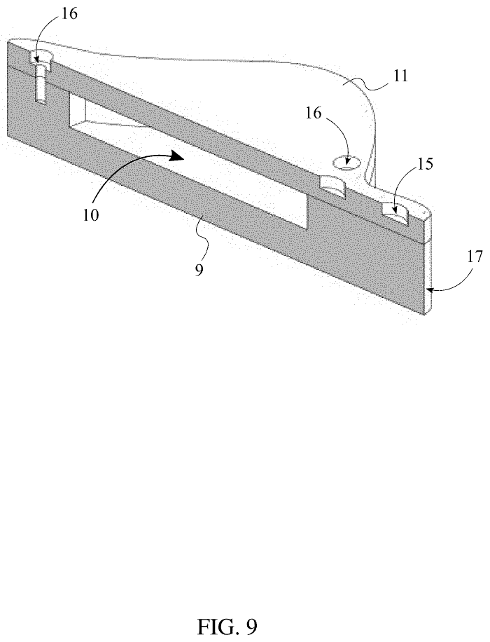

In reference to FIG. 1 through FIG. 9, the present invention is a family tree urn. It is an objective of the present invention to provide users with an assembly that comprises a stand and at least one container that is mounted thereto by fastening means. According to a preferred embodiment of the present invention, the stand is attached to a round base. Where after, the base projects a plurality of protrusions that accommodates the mounting of the at least one container thereto. By mounting the at least one container to a more stable stand and assembly thereof, the at least one container better mitigates the disturbance and possible destruction of the container. Further, by providing the plurality of protrusions to which the at least one container may mount to, the apparatus additionally addresses the concentration of multiple containers, particularly in deference to the sensitive nature an urn should be countenanced for.

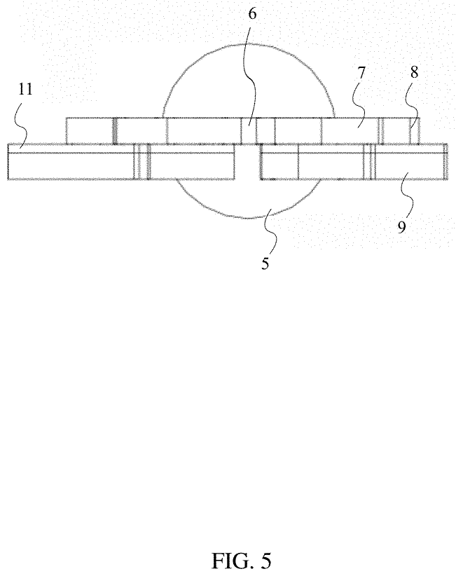

The following description is in reference to FIG. 1 through FIG. 9. According to a preferred embodiment, the present invention comprises a stand 1, at least one container 2, at least one stand fastener 3, and a plurality of cover fasteners 4. Preferably, the stand 1 is composed of a homogenous material that further is preferably rigid enough to resist deformation over time. Further, the stand 1 is composed of a homogenous material that is preferably pliable or yielding enough to facilitate the impregnation of any mounting means thereto. Examples of such material include, but are not limited to wood, hard plastic etc. However, the stand 1 may comprise any other material that is known to one of ordinary skill in the art as long as the objectives of the present invention are fulfilled. The stand 1 further comprises a base 5, an elongated frame 6 and a plurality of protrusions 7. Preferably, the base 5 is terminally connected to the elongated frame 6. More specifically, the elongated frame 6 is attached normally and centrally onto the base 5. As seen in FIG. 1 and FIG. 5, the base 5 is circular. In other words, located at the bottom of the apparatus oriented normal with the ground is the circular base. However, the base 5 may comprise any other size, shape, dimensions, components and arrangement of components, as long as the objectives of the present invention are not hindered. The elongated frame 6 may be attached to the base 5 by sliding a protruding edge of the elongated frame 6 into a slot on the base 5. However, any other attachment means such as adhesives, snap clips, screws etc. may be employed to attach the elongated frame 6 onto the base 5, as long as the intents of the present invention are fulfilled.

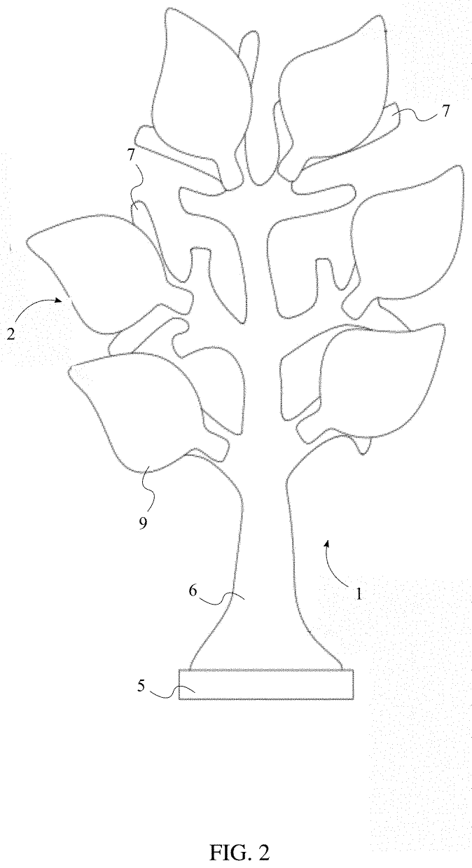

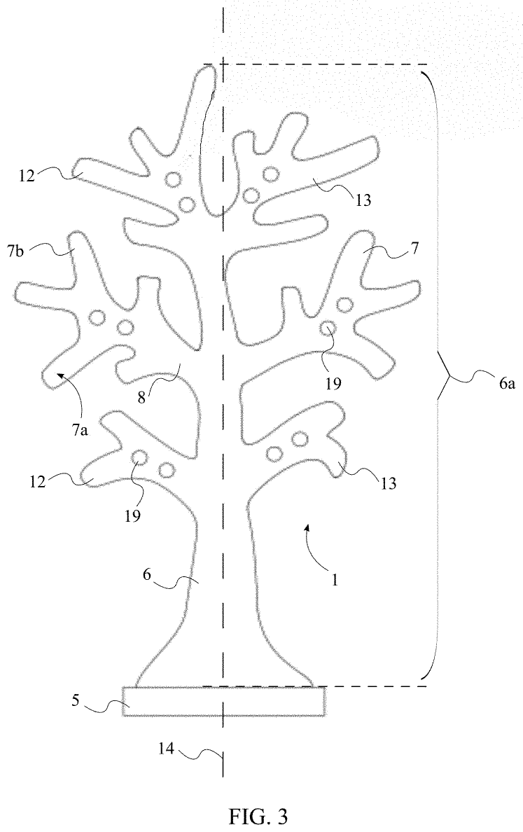

Continuing with the preferred embodiment, the plurality of protrusions 7 is laterally mounted along a length 6a of the elongated frame 6, and the plurality of protrusions 7 is distributed arbitrarily along the length 6a of the elongated frame 6. As seen in FIG. 3, located above the base 5 and arbitrarily fanning outward in a preferably planar arrangement is the plurality of protrusions 7. As seen in FIG. 1 and FIG. 2, the entire arrangement may be summed up as the base 5 comprising a curvilinear disk, with an elongated frame 6 protruding from the top with which the plurality of protrusions 7 project therefrom. The stand 1 further preferably locates the center of gravity near the bottom of the assembly to mitigate tipping thereof and damaging or exposing the at least one container 2. To that end, it is preferred that the base 5 possesses a width relative to the height of the apparatus, supporting the apparatus which mitigates the damage of at least one container 2.

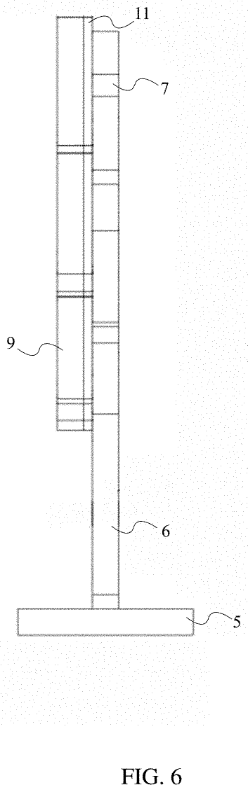

It is an aim of the present invention to hold multiple urns or containers that may hold ashes on a single standing structure. To accomplish this, as seen in FIG. 1 through FIG. 3, the container 2 is normally mounted onto a planar surface 7a of a corresponding protrusion 8, wherein the corresponding protrusion 8 is from the plurality of protrusions 7. Further, as seen in FIG. 5 and FIG. 6, the container 2 is positioned offset from the elongated frame 6 across the corresponding protrusion 8. In order to contain the ashes in a secured manner, the at least one container 2 comprises a receptacle 9, an inner cavity 10, and a cover 11. In the preferred embodiment, the inner cavity 10 traverses into the receptacle 9, and the cover 11 is mounted over the inner cavity 10. The cover 11 acts as a closure or closing attachment for the receptacle 9. As seen in FIG. 1, the receptacle 9 is positioned opposite to the corresponding protrusion 8 across the cover 11. According to the preferred embodiment, the at least one stand fastener 3 is connected between the corresponding protrusion 8 and the container 2, such that the stand fastener 3 securely attaches the container 2 onto the stand 1. Further, the plurality of cover fasteners 4 is connected between the container 2 and the cover 11, such that the cover 11 fastened over the receptacle 9 with the plurality of cover fasteners 4, protects the contents of the inner cavity 10 in a tight and secure fashion. Preferably, the at least one stand fastener 3 comprise a magnet or a wooden dowel, and the plurality of cover fasteners 4 comprise screws and nuts. However, any other fastening means that are known to one of ordinary skill in the art may be used as the stand fastener 3 and the cover fastener 4, as long as the objectives of the present invention are not altered.

A more in-depth description of the various components of the family tree urn follows. As seen in FIG. 3, the plurality of protrusions 7 comprises a plurality of first protrusions 12 and a plurality of second protrusions 13, wherein the plurality of first protrusions 12 is positioned opposite to the plurality of second protrusions 13 across a transverse plane 14 of the elongated frame 6. In other words, the plurality of first protrusions 12 and the plurality of second protrusions 13 are fanned outward on either side of elongated frame 6, thereby enabling a stable planar arrangement for the apparatus. Further, as seen in FIG. 3, each of the plurality of protrusions 7 may diverge into a plurality of third protrusions 7b. In other words, the plurality of protrusions 7 may split into a further subset of a plurality of protrusions 7, thereby providing more surface area to hang more containers, as well as for providing aesthetic appeal. Furthermore, in the preferred embodiment, the plurality of protrusions 7 is positioned coextensively to the elongated frame 6, thereby providing a smooth planar surface for the containers 2 to be mounted to. However, in alternate embodiments, the plurality of protrusions 7 may diverge along multiple directions and orientations around the elongated frame 6, as long as the objectives of the present invention are fulfilled.

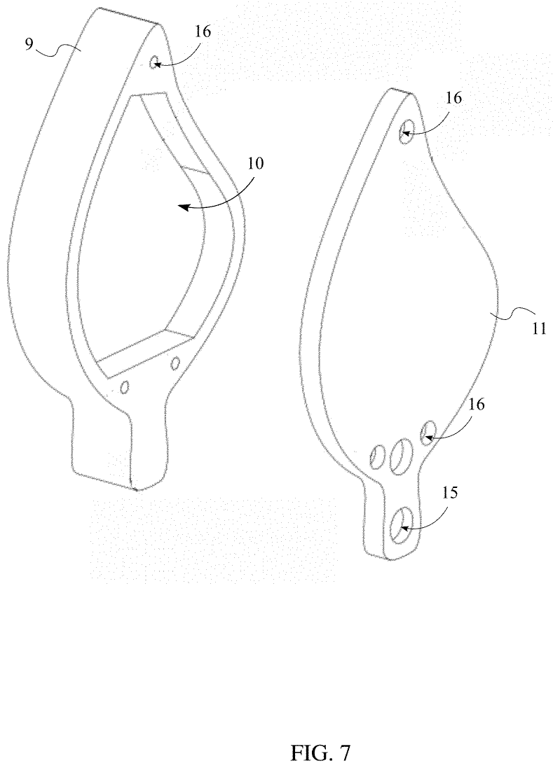

In order to install the necessary fasteners and thus to enable smooth functioning of the present invention, the family tree urn comprises multiple apertures and holes to house the multiple fasteners. To that end, the present invention comprises at least one stand fastener hole 15 and a plurality of cover fastener holes 16. As seen in FIG. 7 through FIG. 9, the at least one stand fastener hole 15 traverses into the cover 11, such that the at least one stand fastener 3 engages into the at least one stand fastener hole 15 and securely connects the stand 1 to the cover 11. Further, the plurality of cover fastener holes 16 traverses into the cover 11 and the receptacle 9, such that the plurality of cover fasteners 4 engages into the plurality of cover fastener holes 16 and connects the cover 11 to the receptacle 9. Bored normal to the planar surface of the cover 11 and coincident in planar location with the plurality of cover fastener holes 16, is the plurality of cover fastener holes 16 in the receptacle 9. Thus, the cover 11 is associated with mounting the individual container through the various fastening means. As seen in FIG. 7, the at least one stand fastener hole 15 is positioned adjacent a terminal end 17 of the cover 11, and the plurality of cover fastener holes 16 is positioned along distal ends of the container 2. In other words, located along distal ends of the individual container and bored normal to the planar surface thereof is the plurality of cover fastener holes 16. Where the plurality of cover fastener holes 16 on the cover 11 is congruent in planar location to the plurality of cover fastener holes 16 on the receptacle 9. The at least one stand fastener hole 15 may further be congruent in cluster arrangements to the mounting means to connect the individual container both to the plurality of protrusions 7 and the cover 11.

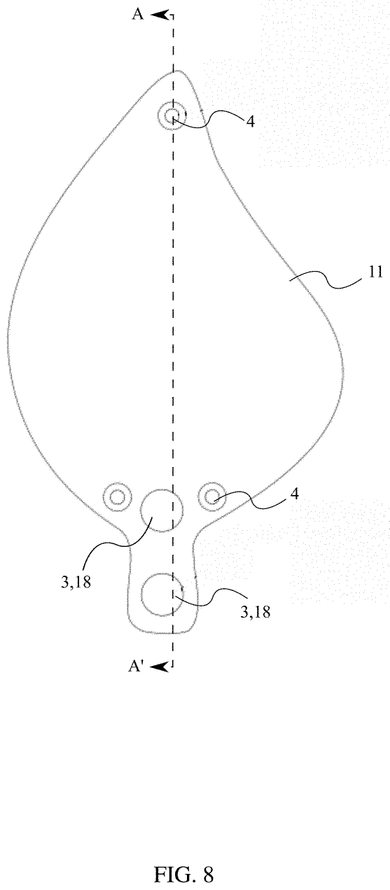

In the preferred embodiment, the means for mounting comprises magnetically attractive zones facilitated between the stand 1 and the at least one container 2. To that end, the stand fastener 3 comprises at least one magnet 18 and a plurality of metal cores 19, such that the magnet 18 facilitates mounting of the container 2 to the plurality of protrusions 7. Preferably, the at least one magnet 18 is positioned within the at least one stand fastener hole 15 and the plurality of metal cores 19 is integrated into the planar surfaces of the plurality of protrusions 7. As seen in FIG. 3, the metal core 19 is integrated within the plurality of protrusions 7, and as seen in FIG. 8, the at least one magnet 18 is positioned towards the terminal end 17 of the cover 11, within the stand fastener hole 15. The magnet 18 is preferably parallel with the planar surface of the container, such that no fastening element protrudes out of the plane and the aesthetic appeal of the apparatus is maintained. Thus, when the at least one container 2 is mounted onto the stand 1, the at least one magnet 18 is aligned with a corresponding metal core, wherein the corresponding metal core is from the plurality of metal cores 19. In other words, the magnet 18 within the at least one container 2 attracts to the metal core 19 within the plurality of protrusions 7.

It is an objective of the present invention to securely and safely hold ashes within the container 2 without causing any kind of contamination or disturbance. In order to accomplish that, it is preferred that the plurality of cover fasteners 4 hermetically seals the inner cavity 10 with the cover 11. In other words, the cover 11 preferably possesses a congruent geometric profile with the container 2. Preferably, the at least one container 2 is organic in geometric profile such as a leaf or similar, wherein the cover 11 delineates a shape of the receptacle 9. As seen in FIG. 1 through FIG. 3, the at least one container 2 mimics the shape of a leaf, and the elongated frame 6 along with the plurality of protrusions 7 mimic the shape of a tree. However, the container 2 and the stand 1 may comprise any other shape, size, components or arrangement of components that are known to one of ordinary skill in the art, as long as the objectives of the present invention are fulfilled.

As seen in FIG. 7, the cavity 10 preferably possesses a geometry offset and lesser than the container 2. Preferably, the cavity 10 is shortened before the exterior-most edge to facilitate a solid surface and body for the plurality of cover fastener holes 16 and the stand fastener hole 15 to bore through. In other words, a first transversal cross section of the inner cavity 10 is smaller than a second transversal cross section of the receptacle 9. Thus, the invention introduces a comprehensive assembly that localizes at least one container to a stationary stand that mitigates damages thereto and may accommodate greater than one container.

Although the invention has been explained in relation to its preferred embodiment, it is to be understood that many other possible modifications and variations can be made without departing from the spirit and scope of the invention.

What is claimed is:

1. An apparatus for holding ashes comprising:
a stand;
at least one container;
at least one stand fastener;
a plurality of cover fasteners;
the stand comprising a base, an elongated frame and a plurality of protrusions;
the base being terminally connected to the elongated frame;
the elongated frame being attached normally and centrally onto the base;
the plurality of protrusions being laterally mounted along a length of the elongated frame;
the plurality of protrusions being distributed arbitrarily along the length of the elongated frame;
the at least one container comprising a receptacle, an inner cavity, and a cover; the at least one container being normally mounted onto a planar surface of a corresponding protrusion, wherein the corresponding protrusion is from the plurality of protrusions;
the at least one container being positioned offset from the elongated frame across the corresponding protrusion;
the inner cavity traversing into the receptacle;
the cover being mounted over the inner cavity;
the receptacle being positioned opposite to the corresponding protrusion across the cover;
the at least one stand fastener being connected between the corresponding protrusion and the at least one container; and
the plurality of cover fasteners being connected between the at least one container and the cover.

2. The apparatus of claim 1 comprising:
the plurality of protrusions comprising a plurality of first protrusions and a plurality of second protrusions; and
the plurality of first protrusions being positioned opposite to the plurality of second protrusions across a transverse plane of the elongated frame.

3. The apparatus of claim 1, wherein each of the plurality of protrusions diverge into a plurality of third protrusions.

4. The apparatus of claim 1, wherein the plurality of protrusions being positioned coextensively to the elongated frame.

5. The apparatus of claim 1, comprising:
at least one stand fastener hole;
a plurality of cover fastener holes;
the at least one stand fastener hole traversing into the cover;
the at least one stand fastener engaging into the at least one stand fastener hole;
the plurality of cover fastener holes traversing into the cover and the receptacle; and
the plurality of cover fasteners engaging into the plurality of cover fastener holes.

6. The apparatus of claim 3, comprising:
the at least one stand fastener hole being positioned adjacent a terminal end of the cover; and
the plurality of cover fastener holes being positioned along distal ends of the container.

7. The apparatus of claim 3, comprising:
the stand fastener comprising at least one magnet and a plurality of metal cores;
the at least one magnet being positioned within the at least one stand fastener hole;
the plurality of metal cores being integrated into the planar surfaces of the plurality of protrusions; and
the at least one magnet being aligned with a corresponding metal core, wherein the corresponding metal core is from the plurality of metal cores.

8. The apparatus of claim 1, wherein the plurality of cover fasteners hermetically seals the inner cavity with the cover.

9. The apparatus of claim 1, wherein the cover delineating a shape of the receptacle.

10. The apparatus of claim 1, comprising:
a first transversal cross section of the inner cavity being smaller than a second transversal cross section of the receptacle.

11. The apparatus of claim 1, wherein the at least one container mimics the shape of a leaf, and the elongated frame along with the plurality of protrusions mimic the shape of a tree.

12. The apparatus of claim 1, wherein the base being circular.

13. An apparatus for holding ashes, comprising:
a stand;
at least one container;
at least one stand fastener;
a plurality of cover fasteners;
at least one stand fastener hole;
a plurality of cover fastener holes;
the stand comprising a base, an elongated frame and a plurality of protrusions;
the base being terminally connected to the elongated frame;
the elongated frame being attached normally and centrally onto the base;
the plurality of protrusions being laterally mounted along a length of the elongated frame;
the plurality of protrusions being distributed arbitrarily along the length of the elongated frame;
the at least one container comprising a receptacle, an inner cavity, and a cover;
the at least one container being normally mounted onto a planar surface of a corresponding protrusion, wherein the corresponding protrusion is from the plurality of protrusions;
the at least one container being positioned offset from the elongated frame across the corresponding protrusion;
the inner cavity traversing into the receptacle;
the cover being mounted over the inner cavity;
the receptacle being positioned opposite to the corresponding protrusion across the cover;
the at least one stand fastener being connected between the corresponding protrusion and the container;
the plurality of cover fasteners being connected between the container and the cover;
the at least one stand fastener hole traversing into the cover;
the at least one stand fastener engaging into the at least one stand fastener hole;
the plurality of cover fastener holes traversing into the cover and the receptacle; and
the plurality of cover fasteners engaging into the plurality of cover fastener holes.

14. The apparatus of claim 13, comprising:
the at least one stand fastener hole being positioned adjacent a terminal end of the cover; and
the plurality of cover fastener holes being positioned along distal ends of the container.

15. The apparatus of claim 13, comprising:
the stand fastener comprising at least one magnet and a plurality of metal cores;
the at least one magnet being positioned within the at least one stand fastener hole;
the plurality of metal cores being integrated into the planar surfaces of the plurality of protrusions; and
the at least one magnet being aligned with a corresponding metal core, wherein the corresponding metal core is from the plurality of metal cores.

16. The apparatus of claim 13, comprising:
the plurality of protrusions comprising a plurality of first protrusions and a plurality of second protrusions;
the plurality of first protrusions being positioned opposite to the plurality of second protrusions across a transverse plane of the elongated frame;
each of the plurality of protrusions diverge into a plurality of third protrusions; and
the plurality of protrusions being positioned coextensively to the elongated frame.

17. The apparatus of claim 13, wherein the plurality of cover fasteners hermetically seals the inner cavity with the cover.

18. The apparatus of claim 13, wherein the cover delineating a shape of the receptacle.

19. The apparatus of claim 13, comprising:
a first transversal cross section of the inner cavity being smaller than a second transversal cross section of the receptacle.

20. The apparatus of claim 1, wherein the base being circular.
